(19) United States
(12) Patent Application Publication
(10) Pub. No.: US 2012/0301780 A1
(43) Pub. Date: Nov. 29, 2012

(54) POSITIVE ELECTRODE ACTIVE MATERIAL FOR LITHIUM ION BATTERY, METHOD FOR PRODUCING THE SAME, POSITIVE ELECTRODE FOR LITHIUM ION BATTERY, AND LITHIUM ION BATTERY

(75) Inventors: Kan KITAGAWA, Hitachinaka (JP); Toyotaka Yuasa, Hitachi (JP)

(73) Assignee: Hitachi Metals, Ltd.

(21) Appl. No.: 13/479,632

(22) Filed: May 24, 2012

(30) Foreign Application Priority Data
May 27, 2011 (JP) 2011-118644

(51) Int. Cl. H01M 4/485; H01M 4/64; H01M 4/04; H01M 4/583; H01M 4/525; H01M 4/505

(52) U.S. Cl. 429/211; 429/231.1; 429/231.3; 429/224; 429/223; 429/221; 252/182.1

(57) ABSTRACT

A positive electrode active material for a lithium ion battery includes a material represented by chemical formula LiMPO₄ where M includes at least one of iron, manganese, cobalt, and nickel. Particles of the positive electrode active material have a diameter d in the range of 10 nm to 200 nm, the diameter d being determined by observation under a transmission electron microscope. A ratio d/D of the diameter d to a crystallite diameter D is in the range of 1 to 1.35, the crystallite diameter D being determined from a half width measured by X-ray diffraction. The positive electrode active material is coated with carbon, an amount of the carbon being in the range of 1 weight percent to 10 weight percent.

### CLAIM OF PRIORITY

The present application claims priority from Japanese Patent Application JP 2011-118644 filed on May 27, 2011, the content of which is hereby incorporated by reference into this application.

### FIELD OF THE INVENTION

The present invention relates to a positive electrode active material for a lithium ion battery, a method for producing the same, a positive electrode for a lithium ion battery, and a lithium ion battery.

### BACKGROUND OF THE INVENTION

Lithium cobalt oxide has been mainly used for a positive electrode active material for a lithium ion battery. Lithium ion batteries using the positive electrode active material have been widely used. Unfortunately, cobalt, which is a raw material of the lithium cobalt oxide, is produced in small quantities and is expensive. Then, alternative materials have been studied. Lithium manganate (lithium manganese oxide), which has a spinel structure, is listed as an alternative material but has an insufficient discharge capacity and suffers from elution of manganese at high temperatures. Lithium nickelate is expected to have a high capacity but has a poor thermal stability at high temperatures.

For these reasons, an olivine-type positive electrode active material (hereinafter simply referred to as “olivine”), which has satisfactory thermal stability and excellent safety, is expected as a positive electrode active material. This is because the olivine has a composition represented by the chemical formula LiMPO₄ (wherein M is a transition metal) and has strong P—O bonds in the structure to prevent oxygen from desorbing even at high temperatures.

The olivine is, however, inferior in electric conductivity and ionic conductivity, which gives the battery insufficient discharge capacity. This is because the strong P—O bonds in the olivine cause localization of electrons.

For higher safety of batteries including lithium ion batteries, polyanionic active materials have been proposed. The polyanionic active materials have a polyanion (an anion including one main group element and plural oxygen bonded thereto, such as PO₄³⁻, BO₃³⁻, and SiO₄⁴⁻) and include LiMPO₄, Li₂MSiO₄, and LiMBO₃ wherein M denotes a transition metal. The polyanionic active materials, however, have poor electric conductivity due to localization of electrons and have the same problem as in the olivine.

To solve such problems and to improve electric conductivity, Japanese Unexamined Patent Application Publication No. 2001-15111 disclose a technique for coating the surface of the olivine with carbon (forming a carbon coating on the surface of the olivine). Independently, to improve the electric conductivity and the ionic conductivity, a technique for making the particle diameter of the olivine small to increase a reaction area and decrease a diffusion length is disclosed in a document by A. Yamada et al. (A. Yamada, S. C. Chung, and K. Hinokuma “Optimized LiFePO₄ for Lithium Battery Cathodes” Journal of the Electrochemical Society 148 (2001), pp. A224-A229).

Carbon coating of an olivine may be performed by a process of mixing the olivine with acetylene black or graphite and bringing them into intimate contact with each other typically using a ball mill, or a process of mixing an olivine with an organic substance, such as a sugar, an organic acid or pitch and sintering the mixture. Exemplary techniques for allowing an olivine to have a small particle diameter include lowering the sintering temperature and mixing the olivine with a carbon source to suppress the growth (for example, Lei Wang, Yudai Huang, Rongrong Jiang, and Dianzeng Jia “Preparation and characterization of nano-sized LiFePO₄ by low heating solid-state coordination method and microwave heating” Electrochimica Acta 52 (2007), pp. 6778-6783).

However, a high capacity is not obtained by merely allowing an olivine to have a small particle diameter or by merely coating an olivine with carbon (Robert Dominko, Marjan Bele, Jean-Michel Goupil, Miran Gaberscek, Darko Hanzel, Iztok Arcon, and Janez Jamnik “Wired Porous Cathode Materials: A Novel Concept for Synthesis of LiFePO₄” Chemistry of Materials 19 (2007), pp. 2960-2969). This indicates that carbon coating and/or reduction in particle diameter, if employed alone, is not enough for improving properties of the olivine.

Japanese Unexamined Patent Application Publication No. 2008-159495 discloses a method for synthetically preparing microparticles of LiFePO₄ as a method for producing an olivine. Japanese Unexamined Patent Application Publication No. 2009-29670 discloses a technique for preparing particles having improved conductive property through carbon coating and reduction in particle diameter. Exemplary processes for synthetically preparing microparticles of LiFePO₄ include a synthetic process using an organic acid complex. In the process using the organic acid complex, raw materials are dissolved using chelating activity of the organic acid to give a solution, the solution being dried to give a material powder including the raw materials uniformly mixed, and the material powder being sintered. Homogenization of the raw materials is considered to be advantageous for improving the crystallinity. However, the material powder, if simply sintered, gives a burned substance having a coarse network structure (for example, Robert Dominko et al.).

As is described above, carbon coating and reduction in particle diameter, if simply performed, are not enough for improving properties of the olivine. As will be described later, satisfactory high properties of the olivine can be obtained by preparing particles having higher crystallinity while performing carbon coating and reduction in particle diameter. However, the above documents fail to disclose a technique for sufficiently improving crystallinity while performing carbon coating and reduction in particle diameter.

The present invention has been made under these circumstances. An object of the present invention is to improve the capacity and the rate performance of a polyanionic active material including an olivine, and to provide a positive electrode active material for a lithium ion battery which has a high capacity and a high rate performance and to provide a method for producing the positive electrode active material. Another object of the present invention is to provide a positive electrode for a lithium ion battery and a lithium ion battery which have a high capacity and a high rate performance.

### SUMMARY OF THE INVENTION

According to an aspect of the present invention, a positive electrode active material for a lithium ion battery has a following feature.

A positive electrode active material for a lithium ion battery includes a material represented by chemical formula LiMPO₄ where M includes at least one of iron, manganese, cobalt, and nickel; wherein particles of the positive electrode active material have a diameter d in the range of 10 nm to 200 nm, the diameter d being determined by observation under a transmission electron microscope; wherein a ratio d/D of the diameter d to a crystallite diameter D is in the range of 1 to 1.35, the crystallite diameter D being determined from a half width measured by X-ray diffraction; and wherein the positive electrode active material is coated with carbon, an amount of the carbon being in the range of 1 weight percent to 10 weight percent.

According to the present invention, the capacity and the rate performance of a polyanionic active material including an olivine are improved, and a positive electrode active material for a lithium ion battery which has a high capacity and a high rate performance and a method for producing the positive electrode active material are provided. In addition, a positive electrode for a lithium ion battery and a lithium ion battery which have a high capacity and a high rate performance are provided.

### BRIEF DESCRIPTION OF THE DRAWINGS

FIG. 1 is a partial cross-sectional view of a lithium ion battery including a positive electrode for a lithium ion battery according to an embodiment of the present invention;

FIG. 2 is a scanning electron microscopic image of a sample synthesized in Example 1;

FIG. 3 is a transmission electron microscopic image of the sample synthesized in Example 1;

FIG. 4 is an X-ray diffraction pattern of the sample synthesized in Example 1; and

FIG. 5 is a charge-discharge curve in measurement of capacity of an electrode prepared using the olivine sample synthesized in Example 1.

### DETAILED DESCRIPTION OF THE PREFERRED EMBODIMENTS

An olivine, if merely undergone carbon coating and reduction in particle diameter, fails to give a battery having a high capacity, as is described above. The inventors revealed olivine properties which cannot be improved by carbon coating and reduction in particle diameter, and explored the way to improve the properties. As a result of studies, the inventors found that improvement in crystallinity is important for improvements in characteristic properties, i.e., an active material having a low crystallinity results in a battery with a low capacity. The crystallinity can be expressed by the ratio of an actual particle diameter to a crystallite diameter, and details of which will be described later. The reason why the crystallinity affects the capacity, which is not exactly clear at this time, is probably as follows. If an active material has low crystallinity, an ion diffusion path in the active material may be divided by impurities or strain, and this may impede diffusion of ions. Alternatively, grain boundaries may be formed in the particles, and a region of the diffusion path with both ends being blocked by the grain boundaries may be inactivated.

As is described above, improvements in properties of olivine require improvements in crystallinity, in addition to improvements in electric conductivity due to carbon coating, and reduction in diffusion length and increase in surface area due to reduction in particle diameter.

An active material, if sintered at a low temperature in order to reduce the particle diameter, has low crystallinity of the particles. Moreover, an active material, if mixed with a carbon source upon synthesis so as to reduce the particle diameter and to improve the conductive property, takes carbon therein upon crystallization, resulting in low crystallinity. Probably for these reasons, properties inherently possessed by the active material are not sufficiently exhibited.

Specifically, an olivine fails to give a sufficient capacity if the problem in resistance, which has been believed as a problem of olivine, is solved by carbon coating and reduction in particle diameter and if this causes low crystallinity.

However, if particles having improved crystallinity can be obtained while performing carbon coating and reduction in particle diameter, the resulting olivine particles can have satisfactory high properties.

A material prepared by the technique of synthesizing microparticles of LiFePO₄ disclosed in JP-A No. 2008-159495 is considered to have a problem in conductive property because the material does not include carbon. This document fails to disclose a technique for reducing the particle diameter and increasing crystallinity in the coexistence of carbon.

An active material prepared by the technique of obtaining particles having improved conductive property disclosed in JP-A No. 2009-29670 may have low crystallinity because the carbon source is added during synthesis.

The present inventors made further studies on synthesis method using an organic acid complex as a synthesis method for solving the problems and achieving the objects. As is disclosed in the document by Robert Dominko et al, if a material powder is merely sintered in the process using an organic acid complex, the resulting sintered article has a coarse network structure. The crystal grains, if grown in the above manner, invite increase in diffusion length and reduction in reaction area and are disadvantageous for high-speed charging and discharging. The inventors also made studies to solve this problem.

As a result of the studies, the present inventors found that an olivine can have improved properties when having a particle diameter, an amount of carbon to cover particles (amount of carbon coating), and crystallinity within specific ranges mentioned below.

To improve the rate performance, the olivine has a particle diameter of 10 nm or more and 200 nm or less. The olivine, when having a particle diameter of 200 nm or less, can have an excellent capacity if the rate is low, by increasing the lithium ion diffusion length and reaction surface area. Olivine particles having a particle diameter of less than 10 nm are difficult to be synthesized and have a relatively large percentage of the particle surface with low crystallinity, and thereby have a low capacity. The olivine preferably has a particle diameter of 10 nm or more and 70 nm or less. The olivine, when having a particle diameter of 70 nm or less, supports high-speed charging and discharging. The olivine, if having a particle diameter of 100 nm or more, may have somewhat insufficient rate performance.

The term “particle diameter” used herein refers to an average particle diameter determined by randomly extracting a sample of a positive electrode active material, and observing the extracted sample in arbitrary three or more view fields under a transmission electron microscope (TEM) to measure particle diameters, and averaging the measured particle diameters. Since each particle is not a true sphere, an average of the major axis and minor axis of the particle in the TEM image is defined as the particle diameter thereof. In this process, forty particles per each view field are extracted in decreasing order of particle diameter from the median, and their particle diameters are averaged.

The olivine active material is coated with carbon in an amount of carbon of 1 weight percent or more and 10 weight percent or less. The olivine, when having an amount of carbon coating of 1 weight percent or more, can suppress a generation of electric isolation of active material in the electrode. The olivine, if having an amount of carbon coating of more than 10 weight percent, may have an insufficient energy density and may have an increased specific surface area due to the presence of carbon, and this may invite aggregation of the slurry and peeling of the positive electrode mix from the electric collector in production of electrode. Preferably, the olivine has an amount of carbon coating of 2 weight percent or more and 5 weight percent or less. When having an amount of carbon coating in this range, the olivine provides such electric conductivity as to be sustainable in high-speed charging and discharging, and minimizes inhibitory effect of the surface carbon layer on lithium diffusion. The amount of carbon coating may be determined by analysis of the positive electrode active material typically through infrared absorptiometry after high-frequency combustion.

The crystallinity of the olivine is indicated by the ratio (d/D) of the particle diameter (d) to the crystallite diameter (D). The crystallinity of the olivine (the ratio d/D) satisfies 1≦(d/D)≦1.35. The olivine has higher crystallinity with a decreasing ratio d/D. The inventors found that a high capacity is obtained when the ratio d/D is 1.35 or less, as described in working examples mentioned later.

The term “crystallite diameter D” used herein refers to a property value which is determined by using a half width in data of X-ray diffraction (XRD). The XRD was performed in a focusing type using Cu Kα line for X-ray with an output of 40 kV and 40 mA. The measured Data, which was obtained under conditions of a step size of 0.03° and a measurement time per one step of 15 seconds, were smoothed by the Savitzky-Goley method, from which the background and Kα₂ line were removed. In this process, the half width βexp of the (101) peak (the space group was Pmna) was determined. In addition, the half width βi was determined by measuring a standard silicon (Si) sample (NIST standard sample 640d) using the same system under the same conditions as above. A half width β is defined according to the following equation:

β=\sqrt{βₑₓₚ²−βᵢ²}

Using the defined half width, the crystallite diameter D is determined according to the following Scherrer equation:

$$D = \frac{K λ}{β cos θ}$$

wherein λ represents the wavelength of the X-ray source, θ represents the reflection angle, and K represents the Scherrer constant, equal to 0.9 herein.

If an olivine has a grain boundary or lattice distortion inside thereof, the crystallite diameter D determined according to the Scherrer equation is smaller even when measured particle diameters of the olivine are identical, resulting in low crystallinity since the ratio d/D of the particle diameter d to the crystallite diameter D is larger.

When an olivine has better crystallinity, a ratio d/D decreases and approaches a value of 1. The minimum value of the ratio d/D is 1 because the crystallite diameter D does not exceed the particle diameter d and is equal to the particle diameter d at the maximum. Accordingly, the crystallinity becomes better as the ratio d/D comes closer to 1.

In the present invention, the transition metal M in the olivine LiMPO₄ includes at least one selected from the group consisting of Fe, Mn, Co, and Ni. In the working examples mentioned later, the transition metal M includes Fe and Mn, or Fe alone. However, using Co and/or Ni as the transition metal M also gives the same advantageous effects as in the working examples.

Advantageous effects of the present invention are more significantly exhibited when the olivine (LiMPO₄, where M is a transition metal) includes 50% or less Fe in the transition metal M. This is probably because other olivines including LiMnPO₄ and LiCoPO₄ have lower reactivity typified by diffusibility than that of LiFePO₄. This is also probably because increase in diffusion resistance due to slight decrease in crystallinity may significantly affect the properties of such other olivines having a small content of Fe, even when this problem is insignificant in olivines having a large content of Fe, such as LiFePO₄. The present invention can overcome the problem or disadvantage of olivines having a small content of Fe. This will be described later based on data in the working examples and comparative examples.

The inventors synthesized positive electrode active materials using a production method (synthesis method) mentioned later, examined on the data of produced positive electrode active materials, and found that the positive electrode active material can have satisfactory excellent properties when the particles of the positive electrode active material have physical properties within the above-specified ranges. Note that a method for producing a positive electrode active material according to the present invention is not limited to the after-mentioned production method because particles are expected to have good properties as long as satisfying the ranges of physical properties.

The inventors invented a novel synthesis method as a method for producing an active material having a particle diameter, an amount of carbon coating, a ratio d/D (crystallinity) of the particle diameter d to the crystallite diameter D, all of which fall in the above-specified ranges. The novel synthesis method serves as a technique for synthesizing microparticles and includes the steps of mixing raw materials to give a material mixture, presintering the mixed raw materials (the material mixture) to give a presintered material, mixing the presintered material with a carbon or an organic substance after the presintered material is pulverized by an action of a mechanical pressure, and sintering the presintered material mixed with a carbon or an organic substance.

According to the synthesis method of the present invention, calcining, which is performed typically by using an electric furnace, includes two stages, a presintering step and a sintering step. In the presintering step which is the first stage, presintering is performed at a temperature equal to or higher than the crystallization temperature of the active material. However, the presintering temperature should not be largely higher than the crystallization temperature and is preferably near to the crystallization temperature (and is equal to or higher than the crystallization temperature). The sintering step which is the second stage is performed at a temperature higher than the presintering temperature in the presintering step.

The step of mixing the presintered material with a carbon or an organic substance after the presintered material is pulverized is performed between the presintering step and the sintering step. In this step, the carbon or the organic substance, which is a carbon source, is brought into intimate contact with crystals by an action of a mechanical pressure and the crystals are coated with carbon.

Particles of the active material synthesized by the method mentioned above are coated with carbon and have a particle diameter of 10 nm or more and 200 nm or less, having a small particle diameter. The presintering step is preferably performed in an oxidizing atmosphere because the resulting particles having a smaller particle diameter and a carbon coating can have further high crystallinity.

This synthesis method may be applied not only to olivines but also to other positive electrode active materials represented by the formula AₓMB_{y}O_{z} having another polyanion such as silicates and borates. In this formula, “A” denotes an alkali metal or alkaline earth metal, “M” includes at least one transition metal element, “B” denotes a main group element capable of covalent binding to oxygen, and x, y and z satisfy 0≦x≦2, 1≦y≦2 and 3≦z≦6, respectively. The element “B” and oxygen O combine with each other to form an anion through covalent binding. These positive electrode active materials including a polyanion have poor electric conductivity as in a case of olivines and should therefore essentially be coated with carbon and reduced in particle diameter. The carbon coating and reduction in particle diameter may invite decrease in crystallinity as described above. However, the synthesis method of the present invention enables carbon coating and reduction in particle diameter of such polyanionic active materials without decrease in crystallinity.

According to the present invention, a polyanionic active material including olivine can have a smaller particle diameter, high conductive property, and high crystallinity. Therefore, a positive electrode for a lithium ion battery and a lithium ion battery which have a high capacity and high rate performance can be provided.

A method for producing a positive electrode active material according to an embodiment of the present invention will be illustrated in detail below.

<Mixing of Raw Materials>

Presintering at a temperature equal to or higher than the crystallization temperature and near to the crystallization temperature allows microcrystals (microparticles) to precipitate. In this process, raw materials for the positive electrode active material preferably have smaller particle diameters because the microcrystals have sizes not smaller than the particle diameters of the raw materials. In addition, the raw materials are preferably mixed uniformly because the raw materials which are not mixed uniformly may cause a precipitation of coarse crystals during presintering or may cause a heterophase.

Exemplary processes for mixing the raw materials include a process of mechanically pulverizing the raw materials with a bead mill, and a process of forming a solution of the raw materials using an acid, an alkali, or a chelating agent and drying the solution. Especially, the latter process is advantageous for precipitation of microcrystals because the raw materials are homogeneously mixed with each other at the molecular level in the solution. Exemplary techniques for drying the solution include simple heating, heating under reduced pressure, and spray drying. Spray pyrolysis, in which drying and presintering are simultaneously performed, may be employed.

The raw materials for the positive electrode active material are preferably salts that do not remain after sintering. A metal source of the raw materials can be at least one selected from acetates, oxalates, citrates, carbonates, and tartrates. The term “metal” here refers to M (transition metal) in the LiMPO₄. The metal M includes at least one selected from the group consisting of Fe, Mn, Co, and Ni. The metal M may further include one or more main group elements such as Mg, Al, Zn, Sn, and Ca in an amount of 10% or less. If such main group elements are present in an amount of more than 10%, the relative amount of elements contributing to charging and discharging through oxidizing and reducing reactions is reduced to undesirably lower the capacity of the battery. Exemplary lithium sources include lithium acetate, lithium carbonate, and lithium hydroxide. Exemplary phosphate ion source include lithium dihydrogen phosphate, ammonium dihydrogen phosphate, and diammonium hydrogen phosphate.

When a part of the transition metal (at least one of Fe, Mn, Co, and Ni) in the olivine is substituted, the substitution can be performed by simultaneously dissolving a source of element to be substituted in an amount to be substituted. For example, magnesium hydroxide is used for the substitution of magnesium; aluminum hydroxide is used for the substitution of aluminum; and molybdic acid is used for the substitution of molybdenum.

To suppress the growth of microcrystals, the raw materials are preferably dispersed in any matrix. The raw materials dispersed in a matrix are inhibited from growth of microparticles. Microcrystals, if precipitated in the absence of matrix, may become coarse because there are many contact points between the microcrystals. Microcrystals, if precipitated in the presence of matrix, have limited contact points and combine only partially with each other, giving a fine network structure. The network structure, when having a fine or thin network, can be easily pulverized in a subsequent step. After sintering, the matrix should burn off or be converted into a substance favorably affecting the properties of the active material so as to avoid adverse effects on the active material.

Examples of such matrix include carbon and organic substances such as sugars and organic acids. The organic substance will burn off when sintered in an oxidizing atmosphere. Even when such an organic substance is sintered in an oxidizing atmosphere and burns off, residual space formed by the burning off helps to reduce the contact points between microcrystals and exhibits effects of suppressing the growth of microcrystals. The organic substance, when sintered in an inert atmosphere or reducing atmosphere, remains as carbon. The carbon is useful since it suppresses the growth of microcrystals and covers the surface of the active material to improve the conductive property.

In a preferred embodiment, the raw materials are dissolved by the chelating effect of an organic acid to give a solution, and the solution is dried. This technique is effective since it enables simultaneous performing of size reduction, uniform mixing, and dispersion in a matrix for the raw materials. Exemplary organic acids to be added to the raw materials include citric acid, tartaric acid, malic acid, oxalic acid, acetic acid, and formic acid.

<Presintering>

For precipitation of crystals, the presintering temperature should be equal to or higher than the crystallization temperature. Presintering, if performed at a temperature lower than the crystallization temperature, gives an amorphous presintered material because crystals are not precipitated. Such an amorphous material gives coarse particles even after pulverization and sintering. The particle diameter of synthesized particles may be controlled by elevating the presintering temperature. However, presintering at an excessively high temperature may invite coarse particles.

The range of presintering temperature varies depending on active materials because the crystallization temperature and growth speed vary depending on active materials. An olivine, which has a crystallization temperature of around 420° C., should be presintered at a temperature of 420° C. or higher. Presintering at a temperature of 600° C. or lower can suppress the growth of particles. Presintering at a temperature of higher than 600° C. may significantly accelerate the growth of particles, which is unsuitable. Even if carbon or an organic substance is added as a material to suppress the growth, the resulting microcrystals are not completely covered with carbon (carbonized organic substance or added carbon) because the particles significantly vary in the volume between before and after decomposition of the raw materials. For this reason, microcrystals, if undergone acceleration of crystal growth at a high temperature, may combine with each other and grow through gaps of the carbon coating, and the network structure may grow to have a thickness (gauge) of 500 nm or more.

A preferable presintering temperature in the case of an olivine is in the range of 440° C. or higher to 500° C. or lower. Presintering at a temperature of 440° C. or higher allows the entire sample to be equal to or higher than the crystallization temperature even if the sample has somewhat uneven temperature distribution in it. Presintering at a temperature of 500° C. or lower allows the network structure to have a thickness of 100 nm or less, and the resulting presintered material is pulverized and sintered to give microparticles having a particle diameter of several tens of nanometers.

The presintering atmosphere may be any of an inert atmosphere, a reducing atmosphere, and an oxidizing atmosphere.

The inert atmosphere may, for example, be an argon or nitrogen atmosphere. An example of the reducing atmosphere may be an atmosphere of hydrogen or a mixture of hydrogen and an inert gas. As the oxidizing atmosphere, an oxygen-containing gas is desirably used for convenience. Air is preferred as the oxygen-containing gas in consideration of cost.

Upon presintering in an oxidizing atmosphere, the added carbon or organic substance burns off due to combustion, as described above. In this case, when presintering is performed at a suitable temperature, space formed after burning off suppresses the growth of microcrystals. In addition, the burning off of carbon prevents the contamination or migration of carbon into the crystals. For these reasons, presintering in an oxidizing atmosphere helps the active material to have higher crystallinity than those in an inert atmosphere or in a reducing atmosphere. Particularly, when the carbon source is mixed with the raw materials through the state of a solution, the carbon source and the raw materials being uniformly mixed, carbon is easily taken in an inert atmosphere or reducing atmosphere. Accordingly, presintering in an oxidizing atmosphere is more effective for increasing the crystallinity.

The microcrystals prepared through presintering in the above manner are coated with carbon and sintered according to the procedure mentioned below. This improves the crystallinity of the microparticles coated with carbon.

<Mixing and Coating with Carbon Source>

Microcrystals formed through presintering (presintered material) have low crystallinity and should be sintered at a higher temperature so as to have higher crystallinity. However, the microcrystals, if merely sintered at a high temperature, may be combined with each other and grow. To avoid this, the inventors developed a technique for suppressing the growth of crystals. According to this technique, the crystal growth is suppressed by mixing the microcrystals formed through presintering with an organic substance or fine particles of carbon such as acetylene black to give a mixture, and by applying a mechanical pressure to the mixture to make the organic substance or carbon stick intimately to the microcrystals, coating the microcrystals with the organic substance or carbon.

Even when a part of the microcrystals are combined with each other to form a network structure, the network structure can be easily broken by applying a mechanical pressure to give fine microcrystals, if the network structure is a thin structure of a thickness of 500 nm or less. The mechanical pressure is preferably applied by using a ball mill or bead mill for efficient coating and size reduction.

The resulting presintered material, which has been reduced in size and coated with carbon therearound, can suppress grain growth even when sintered at a high temperature. When presintering is performed in an inert atmosphere or reducing atmosphere, the presintered material can be coated with carbon by applying a pressure in a ball mill, for example, because the added carbon or the decomposed product of the organic substance remains. When presintering is performed in an oxidizing atmosphere, the carbon or the organic substance having burned off, carbon coating on the surface of the presintered material should be performed by newly adding a carbon source, by mixing the added carbon source with the presintered material, and by pulverizing the mixture. Examples of the carbon source to be added in this step include, as in the presintering step, carbon and organic substances such as sugars and organic acids. Specifically, examples of the carbon source include sugars such as sucrose and fructose, organic acids such as citric acid and ascorbic acid, and pitch based carbon.

<Sintering>

The sintering carbonizes the organic substance to increase the conductive property and improves the crystallinity of the active material particles. The sintering is preferably performed in an inert atmosphere or reducing atmosphere so as to prevent oxidation of the metal element(s) and to coat the particles with carbon. The sintering temperature is preferably 600° C. or higher to carbonize the organic substance and to improve conductive property. The sintering is preferably performed at a temperature equal to or lower than the temperature at which the active material thermally decomposes. In the case of an olivine, the sintering temperature is preferably in the range of 600° C. or higher to 850° C. or lower. Sintering at a temperature of 600° C. or higher can carbonize the carbon source to impart high conductive property to the active material. Sintering at a temperature of 850° C. or lower does not cause the decomposition of the active material. The sintering temperature is more preferably 700° C. or higher and 750° C. or lower. Sintering performed at a temperature in this range sufficiently improves the conductive property of the carbon and suppresses the formation of impurities due to the reaction between carbon and the olivine.

The method for producing a positive electrode active material according to the present invention, as described above, enables the synthesis of particles which have a smaller particle diameter and are coated with carbon. When presintering is performed in an oxidizing atmosphere, the production method can further improve the crystallinity of the particles which have a smaller particle diameter and are coated with carbon.

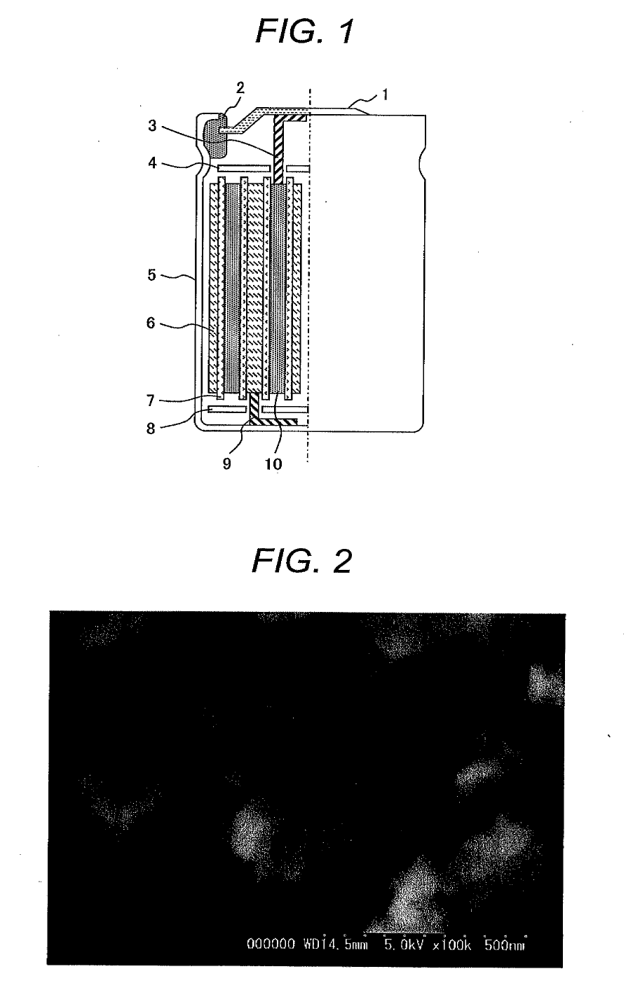

With reference to FIG. 1, a positive electrode for a lithium ion battery and a lithium ion battery according to embodiments of the present invention will be illustrated below. FIG. 1 is a partial cross-sectional view of an exemplary lithium ion battery including a positive electrode for a lithium ion battery according to the present invention. FIG. 1 illustrates a cylindrical lithium ion battery by an example. The lithium ion battery includes a positive electrode (a positive electrode for a lithium ion battery according to the present invention) 10, a negative electrode 6, a separator 7, a positive electrode lead 3, a negative electrode lead 9, a battery cap 1, a gasket 2, an insulating plate 4, an insulating plate 8, and a battery casing 5. The positive electrode 10 and the negative electrode 6 are wound with the separator 7 between them. The separator 7 is impregnated with an electrolyte solution including an electrolyte dissolved in a solvent.

The positive electrode 10, the negative electrode 6, the separator 7, and the electrolyte will be illustrated in detail below.

(1) Positive Electrode

The positive electrode for a lithium ion battery according to an embodiment of the present invention includes a positive electrode active material, a binder, and an electric collector. A layer of a positive electrode mix including the positive electrode active material and the binder is formed on the electric collector. The positive electrode mix may further include a conductive additive, if needed, so as to enhance electric conductivity.

The positive electrode active material, the binder, the conductive additive, and the electric collector, which are included in the positive electrode according to the present embodiment, will be illustrated in detail below.

A) Positive Electrode Active Material

The positive electrode active material according to the embodiment herein employs an active material having the above-specified properties or an active material synthesized by the production method (synthesis method) mentioned above.

B) Binder

Any of binders available for general use can be advantageously employed for the binder, such as PVDF (poly(vinylidene fluoride)) or polyacrylonitrile. The type of binder is not limited as long as having sufficient binding properties.

C) Conductive Additive

The positive electrode can include a firm electroconductive network formed by employing a binder with satisfactory adhesion as mentioned above and a conductive additive for enhancing conductive property. This network improves the conductive property of the positive electrode and also improves the capacity and rate performance of the battery. The conductive additive and the amount thereof to be used in the positive electrode according to the embodiment will be described below.

Exemplary conductive additives usable herein include carbon conductive additives such as acetylene black and graphite powder. In a preferred embodiment, the positive electrode active material is an olivine Mn positive electrode active material because this has a high specific surface area. In this case, the conductive additive preferably has a large specific surface area to form an electroconductive network. Specifically, acetylene black is preferred for the conductive additive. When the positive-electrode active material is coated with carbon, the coating carbon can be used as the conductive additive.

D) Electric Collector

The electric collector (a current collector) may be an electroconductive support such as aluminum foil.

In a preferred embodiment as described above, the positive electrode includes an olivine Mn positive electrode active material as a positive electrode active material, an acrylonitrile copolymer as a binder, and a conductive additive (coating carbon on the active material is included in the conductive additive when the positive electrode active material is coated with the carbon) to obtain a positive electrode having a high capacity and high rate performance.

(2) Negative Electrode

The negative electrode of the lithium ion battery according to an embodiment of the present invention includes a negative electrode active material, a conductive additive, a binder, and an electric collector.

The negative electrode active material can be any material capable of intercalating and desorbing lithium (Li) reversibly through charging and discharging. Examples of such negative electrode active materials include carbon materials, metal oxides, metal sulfides, lithium metal, and alloys of lithium metal with another metal of different kind. Exemplary carbon materials usable herein include graphite, amorphous carbon, coke, and pyrolytic carbon.

Any common conductive additive can be used for the conductive additive, such as carbon conductive additive including acetylene black and graphite powder. Any common binder can be used for the binder, such as PVDF (poly(vinylidene fluoride)), SBR (styrene-butadiene rubber), and NBR (acrylonitrile-butadiene rubber). Any common electric collector can be used for the electric collector, such as an electroconductive support including copper foil.

(3) Separator

The separator may be made from any known material, such as porous polyolefin membrane including polypropylene and polyethylene, and glass fiber sheet.

(4) Electrolyte

Examples of the electrolyte include a lithium salt such as LiPF₆, LiBF₄, LiCF₃SO₃, LiN(SO₂CF₃)₂ or LiN(SO₂F)₂ and a combination thereof. Examples of the solvent which dissolves the lithium salt include chain carbonate, cyclic carbonate, cyclic ester, and nitrile compound. Specific examples of the solvent include ethylene carbonate, propylene carbonate, diethyl carbonate, dimethoxyethane, γ-butyrolactone, n-methylpyrrolidine, and acetonitrile.

Examples of the electrolyte further include polymer gel electrolyte and solid electrolyte.

Various forms of lithium secondary batteries can be structured by using the positive electrode, the negative electrode, the separator, and the electrolyte, such as a cylindrical battery, a square battery, and a laminated battery.

Examples of synthesizing positive electrode active materials according to the present invention will be illustrated below. In addition, properties (capacity and rate performance) of electrodes prepared by using the synthesized positive electrode active materials will be described.

### Example 1

### Synthesis of Positive Electrode Active Material

Iron citrate (FeC₆H₅O₇.nH₂O) and manganese acetate tetrahydrate (Mn(CH₃COO)₂.4H₂O) as metal sources were weighed so as to give a ratio of Fe to Mn of 2:8, and were dissolved in pure water. Citric acid monohydrate (C₆H₈O₇.H₂O) as a chelating agent was added to the mixture of the metal sources and the pure water. The amount of the chelating agent was adjusted depending on the amounts of other citrates so that the amount of citric acid ions was 80 mole percent of the total amount of metal ions. Coordinating citric acid ions around metal ions suppresses the formation of precipitates and thereby gives a solution of uniformly dissolved raw materials.

Next, lithium dihydrogen phosphate and a lithium acetate aqueous solution were added to the solution, and thereby a solution containing all the raw materials dissolved therein was yielded. The solution had a concentration of 0.2 mol/l in terms of metal ions.

The charge composition in terms of Li:M (metal ion):PO₄ was 1.05:1:1, which was lithium excess. This charge composition was employed to prevent cation mixing and supplement loss of lithium by evaporation upon sintering. Even when lithium phosphate (Li₃PO₄) is formed due to excessive lithium, it gives a small adverse effect because of its high conductivity for lithium ions.

Next, the solution was dried by spray drying at an inlet temperature of 195° C. and an outlet temperature of 80° C., and thereby a material powder was yielded. The material powder included respective elements of it uniformly dispersed in citric acid matrix.

The material powder was presintered in a box electric furnace to give a presintered material. The presintering was performed in an atmosphere of air at a presintering temperature of 440° C. for a presintering time of 10 hours. Sucrose was added to the presintered material in an amount of 7 weight percent as a carbon source and an agent for regulating particle diameter. The presintered material with sucrose was pulverized and mixed by a ball mill for 2 hours. In the step using the ball mill, ethanol was used as a dispersion medium. Next, sintering was performed using a tubular furnace, the atmosphere of which can be controlled, in an argon (Ar) atmosphere at a sintering temperature of 700° C. for a sintering time of 10 hours.

These steps gave an olivine LiFe_{0.2}Mn_{0.8}PO₄ coated with carbon. The sample had a particle diameter d of 39 nm, a crystallite diameter D of 32 nm, and an amount of carbon coating of 2.7 weight percent.

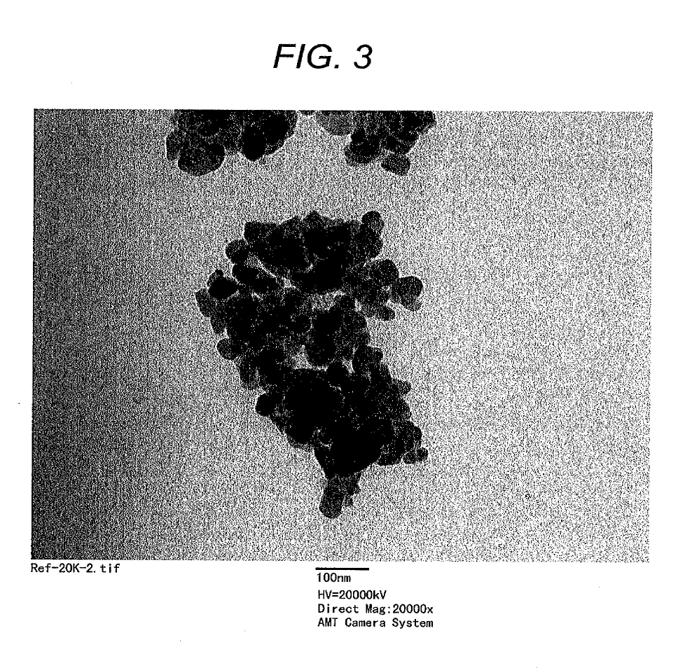

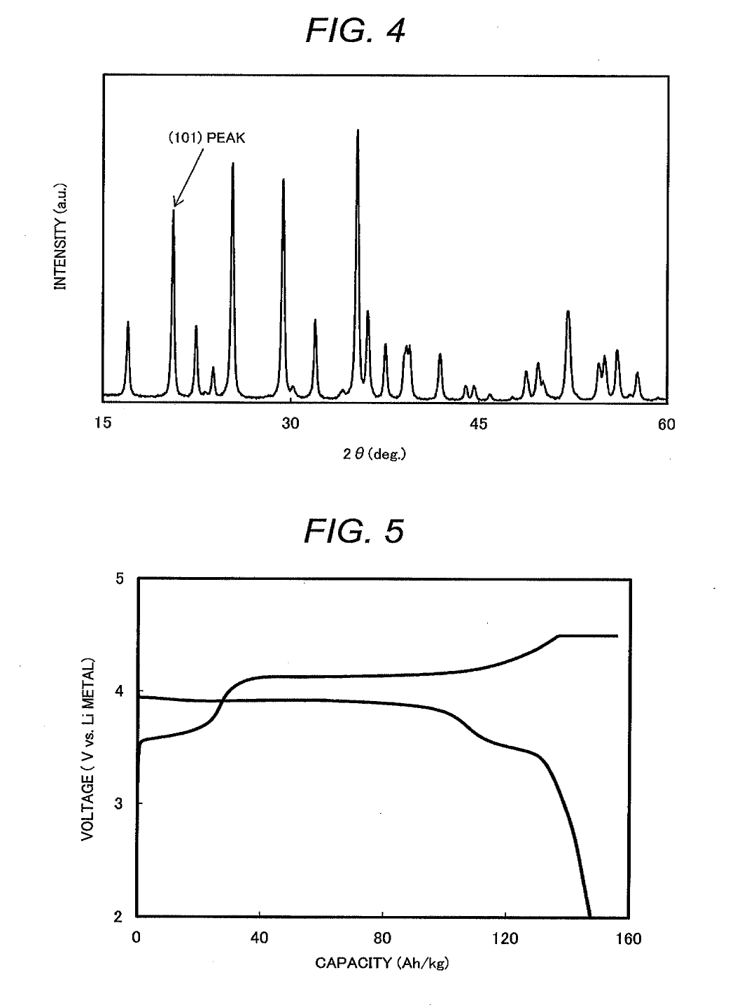

FIG. 2 is a scanning electron microscopic image of the sample synthesized in Example 1. The observation was performed using a scanning electron microscope S-4300 (Hitachi High-Technologies Corporation). FIG. 3 is a transmission electron microscopic image of the sample synthesized in Example 1. The observation was performed using a transmission electron microscope HF-2000 (Hitachi High-Technologies Corporation). FIG. 4 is an X-ray diffraction (XRD) pattern of the sample synthesized in Example 1. The observation was performed using an X-ray diffractometer RINT (Rigaku Corporation).

### Example 2

LiFe_{0.2}Mn_{0.77}Mg_{0.03}PO₄ was synthetically prepared by the same procedure as of Example 1, except for using iron citrate (FeC₆H₅O₇.nH₂O), manganese acetate tetrahydrate (Mn(CH₃COO)₂.4H₂O), and magnesium hydroxide (Mg(OH)₂) in a ratio of Fe:Mn:Mg of 2:7.7:0.3 as metal sources. The sample had a particle diameter d of 40 nm, a crystallite diameter D of 30 nm, and an amount of carbon coating of 2.6 weight percent.

### Example 3

LiFe_{0.6}Mn_{0.4}PO₄ was synthetically prepared by the same procedure as of Example 1, except for using iron citrate (FeC₆H₅O₇.nH₂O) and manganese acetate tetrahydrate (Mn(CH₃COO)₂.4H₂O) in a ratio of Fe:Mn of 6:4 as metal sources. The sample had a particle diameter d of 45 nm, a crystallite diameter D of 36 nm, and an amount of carbon coating of 2.8 weight percent.

### Example 4

LiFe_{0.4}Mn_{0.6}PO₄ was synthetically prepared by the same procedure as of Example 1, except for using iron citrate (FeC₆H₅O₇.nH₂O) and manganese acetate tetrahydrate (Mn(CH₃COO)₂.4H₂O) in a ratio of Fe:Mn of 4:6 as metal sources. The sample had a particle diameter d of 48 nm, a crystallite diameter D of 37 nm, and an amount of carbon coating of 2.8 weight percent.

### Example 5

LiFePO₄ was synthetically prepared by the same procedure as of Example 1, except for using iron citrate (FeC₆H₅O₇.nH₂O) alone as a metal source. Only in this sample, the amount of citric acid ion in the material powder is 100 mole percent of the metal ion (Fe in Example 5). The sample had a particle diameter d of 42 nm, a crystallite diameter D of 33 nm, and an amount of carbon coating of 2.7 weight percent.

### Example 6

LiFe_{0.2}Mn_{0.8}PO₄ was synthetically prepared by the same procedure as of Example 1, except for performing presintering at a temperature of 500° C. The sample had a particle diameter d of 66 nm, a crystallite diameter D of 50 nm, and an amount of carbon coating of 2.6 weight percent.

### Example 7

LiFe_{0.2}Mn_{0.8}PO₄ was synthetically prepared by the same procedure as of Example 1, except for performing presintering at a temperature of 600° C. The sample had a particle diameter d of 154 nm, a crystallite diameter D of 125 nm, and an amount of carbon coating of 2.6 weight percent.

### Example 8

LiFe_{0.2}Mn_{0.8}PO₄ was synthetically prepared by the same procedure as of Example 1, except for adding sucrose in an amount of 24 weight percent. The sample had a particle diameter d of 35 nm, a crystallite diameter D of 26 nm, and an amount of carbon coating of 9.1 weight percent.

### Example 9

LiFe_{0.2}Mn_{0.8}PO₄ was synthetically prepared by the same procedure as of Example 1, except for adding sucrose in an amount of 3 weight percent. The sample had a particle diameter d of 46 nm, a crystallite diameter D of 35 nm, and an amount of carbon coating of 1.1 weight percent.

### Comparative Example 1

LiFe_{0.2}Mn_{0.8}PO₄ was synthetically prepared by the same procedure as of Example 1, except for performing presintering at a temperature of 700° C. The sample had a particle diameter d of 350 nm, a crystallite diameter D of 290 nm, and an amount of carbon coating of 2.7 weight percent.

### Comparative Example 2

LiFe_{0.2}Mn_{0.8}PO₄ was synthetically prepared by the same procedure as of Example 1, except for performing presintering in an argon atmosphere and except for not adding sucrose after presintering. In this sample, sucrose being not added, citric acid did not burn off and served as a carbon source. The sample had a particle diameter d of 35 nm, a crystallite diameter D of 22 nm, and an amount of carbon coating of 6.3 weight percent.

### Comparative Example 3

LiFe_{0.6}Mn_{0.4}PO₄ was synthetically prepared by the same procedure as of Example 3, except for performing presintering in an argon atmosphere and except for not adding sucrose after presintering. In this sample, sucrose being not added, citric acid did not burn off and served as a carbon source. The sample had a particle diameter d of 37 nm, a crystallite diameter D of 21 nm, and an amount of carbon coating of 6.2 weight percent.

### Comparative Example 4

LiFe_{0.4}Mn_{0.6}PO₄ was synthetically prepared by the same procedure as of Example 4, except for performing presintering in an argon atmosphere and except for not adding sucrose after presintering. In this sample, sucrose being not added, citric acid did not burn off and served as a carbon source. The sample had a particle diameter d of 40 nm, a crystallite diameter D of 22 nm, and an amount of carbon coating of 6.5 weight percent.

### Comparative Example 5

LiFePO₄ was synthetically prepared by the same procedure as of Example 5, except for performing presintering in an argon atmosphere and except for not adding sucrose after presintering. In this sample, sucrose being not added, citric acid did not burn off and served as a carbon source. The sample had a particle diameter d of 41 nm, a crystallite diameter D of 25 nm, and an amount of carbon coating of 6.4 weight percent.

### Comparative Example 6

LiFe_{0.2}Mn_{0.8}PO₄ was synthetically prepared by the same procedure as of Example 1, except for adding sucrose in an amount of 45 weight percent. The sample had a particle diameter d of 33 nm, a crystallite diameter D of 25 nm, and an amount of carbon coating of 17 weight percent.

### Comparative Example 7

LiFe_{0.2}Mn_{0.8}PO₄ was synthetically prepared by the same procedure as of Example 1, except for adding sucrose in an amount of 1 weight percent. The sample had a particle diameter d of 50 nm, a crystallite diameter D of 41 nm, and an amount of carbon coating of 0.3 weight percent.

### Comparative Example 8

LiFe_{0.2}Mn_{0.8}PO₄ was synthetically prepared by the same procedure as of Example 1, except for not performing presintering, except for performing pulverization by a ball mill for 2 hours after sintering, and except for not adding sucrose. In the pulverization step using the ball mill, ethanol was used as a dispersion medium. The sample had a particle diameter d of 650 nm, a crystallite diameter D of 415 nm, and an amount of carbon coating of 6.2 weight percent.

### Comparative Example 9

LiFe_{0.2}Mn_{0.8}PO₄ was synthetically prepared by the same procedure as of Comparative Example 2, except for not performing pulverization by a ball mill after presintering. The sample had a particle diameter d of more than 5 μm and had a coarse network structure, which significantly deviates from a spherical shape. The sample had a crystallite diameter D of 1000 nm or more determined by XRD and an amount of carbon coating of 6.8 weight percent.

Table 1 shows the compositions and synthesis conditions of the olivines of Examples 1 to 9 and Comparative Examples (Com. Ex. for short) 1 to 9. Table 2 shows the particle diameter d, crystallite diameter D, and amount of carbon coating of the olivines of Examples 1 to 9 and Comparative Examples 1 to 9, which are the physical properties of the synthesized olivines (physical properties of the samples).

TABLE 1

| | | Presence or | Presintering | | Presence or absence of | Amount of added |
|---|---|---|---|---|---|---|
| | | absence of | temperature | Presintering | ball milling after | sucrose |
| | Composition | presintering | (° C.) | atmosphere | presintering | (weight percent) |
| Example 1 | LiFe_{0.2}Mn_{0.8}PO₄ | present | 440 | air | present | 7 |
| Example 2 | LiFe_{0.2}Mn_{0.77}Mg_{0.03}PO₄ | present | 440 | air | present | 7 |
| Example 3 | LiFe_{0.6}Mn_{0.4}PO₄ | present | 440 | air | present | 7 |
| Example 4 | LiFe_{0.4}Mn_{0.6}PO₄ | present | 440 | air | present | 7 |
| Example 5 | LiFePO₄ | present | 440 | air | present | 7 |
| Example 6 | LiFe_{0.2}Mn_{0.8}PO₄ | present | 500 | air | present | 7 |
| Example 7 | LiFe_{0.2}Mn_{0.8}PO₄ | present | 600 | air | present | 7 |
| Example 8 | LiFe_{0.2}Mn_{0.8}PO₄ | present | 440 | air | present | 24 |
| Example 9 | LiFe_{0.2}Mn_{0.8}PO₄ | present | 440 | air | present | 3 |
| Com. Ex. 1 | LiFe_{0.2}Mn_{0.8}PO₄ | present | 700 | air | present | 7 |
| Com. Ex. 2 | LiFe_{0.2}Mn_{0.8}PO₄ | present | 440 | Ar | present | 0* |
| Com. Ex. 3 | LiFe_{0.6}Mn_{0.4}PO₄ | present | 440 | Ar | present | 0* |
| Com. Ex. 4 | LiFe_{0.4}Mn_{0.6}PO₄ | present | 440 | Ar | present | 0* |
| Com. Ex. 5 | LiFePO₄ | present | 440 | Ar | present | 0* |
| Com. Ex. 6 | LiFe_{0.2}Mn_{0.8}PO₄ | present | 440 | air | present | 45 |
| Com. Ex. 7 | LiFe_{0.2}Mn_{0.8}PO₄ | present | 440 | air | present | 1 |
| Com. Ex. 8 | LiFe_{0.2}Mn_{0.8}PO₄ | absent | — | — | ball milling after sintering | 0* |
| Com. Ex. 9 | LiFe_{0.2}Mn_{0.8}PO₄ | present | 440 | Ar | absent | 0* |

*Citric acid is a carbon source.

TABLE 2

| | Particle | Crystallite | Ratio d/D of | Amount of |
|---|---|---|---|---|
| | diameter | diameter | particle diameter | carbon |
| | d | D | to crystallite | coating (weight |
| | (nm) | (nm) | diameter | percent) |
| Example 1 | 39 | 32 | 1.22 | 2.7 |
| Example 2 | 40 | 30 | 1.33 | 2.6 |
| Example 3 | 45 | 36 | 1.25 | 2.8 |
| Example 4 | 48 | 37 | 1.30 | 2.8 |
| Example 5 | 42 | 33 | 1.27 | 2.7 |
| Example 6 | 66 | 50 | 1.32 | 2.6 |
| Example 7 | 154 | 125 | 1.23 | 2.6 |
| Example 8 | 35 | 26 | 1.35 | 9.1 |
| Example 9 | 46 | 35 | 1.31 | 1.1 |
| Com. Ex. 1 | 350 | 290 | 1.21 | 2.7 |
| Com. Ex. 2 | 35 | 22 | 1.59 | 6.3 |
| Com. Ex. 3 | 37 | 21 | 1.76 | 6.2 |
| Com. Ex. 4 | 40 | 22 | 1.82 | 6.5 |
| Com. Ex. 5 | 41 | 25 | 1.64 | 6.4 |
| Com. Ex. 6 | 33 | 25 | 1.32 | 17 |
| Com. Ex. 7 | 50 | 41 | 1.22 | 0.3 |
| Com. Ex. 8 | 650 | 415 | 1.57 | 6.2 |
| Com. Ex. 9 | ≧5000 | ≧1000 | — | 6.8 |

In Examples 1 to 5, olivines having different compositions were synthesized. A particle diameter d, a crystallinity D, and an amount of carbon coating were controlled within suitable ranges for all the olivines of Examples 1 to 5.

Comparison among Example 1, Example 6, Example 7, and Comparative Example 1 shows that the particle diameter d increases as the presintering temperature rises.

Comparisons between Example 1 and Comparative Example 2, between Example 3 and Comparative Example 3, between Example 4 and Comparative Example 4, and between Example 5 and Comparative Example 5 show that the samples undergone presintering in an argon atmosphere have larger ratios d/D of the particle diameter d to the crystallite diameter D than the samples undergone presintering in an air atmosphere have. However, the samples undergone presintering in an argon atmosphere have particle diameters d of from 35 to 41 nm, indicating particles having small diameters can be obtained even through presintering in an argon atmosphere.

Comparison among Example 1, Example 8, Example 9, Comparative Example 6, and Comparative Example 7 shows that the amount of carbon coating can be arbitrarily controlled by changing the amount of sucrose to be added. The samples of these cases have ratios d/D of the particle diameter d to the crystallite diameter D of 1.35 or less, indicating high crystallinity can be maintained even when an amount of sucrose to be added is changed.

The data of Comparative Example 8 shows that a sample synthesized without presintering and with a ball mill after sintering fails to have a small particle diameter d and has a large ratio d/D of 1.57, leading to low crystallinity.

The data of Comparative Example 9 shows that a sample synthesized without the step of ball milling to bring the carbon source into intimate contact with the material after presintering has coarse particles after sintering.

<Preparation of Electrode, and Measurements of Capacity and Rate Performance>

Electrodes (positive electrodes) were prepared using the olivines synthesized in Examples 1 to 9 and Comparative Examples 1 to 9, and properties, i.e., capacity and rate performance, of the electrodes were measured. All the electrodes were prepared by the same process. The process for preparing the electrodes will be described below.

A slurry was prepared by kneading a positive electrode active material, a conductive additive, a binder, and a solvent (dispersion medium) in a mortar. The olivines synthesized in Examples 1 to 9 and Comparative Examples 1 to 9 were used for the positive electrode active materials. The conductive additive used herein was acetylene black (DENKA BLACK (registered trademark), DENKI KAGAKU KOGYO KABUSHIKI KAISHA), the binder was a modified polyacrylonitrile, and the dispersion medium was N-methyl-2-pyrrolidone (NMP). The binder was dissolved in NMP to be a solution having a concentration of 6.0%. The electrode was designed to have a composition such that the weight ratio of the positive electrode active material, the conductive additive, and the binder was 82.5:10:7.5.

The prepared slurry was applied to an aluminum foil having a thickness of 20 μm by using a blade with a gap of 250 μm. The amount of coating of the slurry on the aluminum foil was 5 to 6 mg/cm². This slurry was dried at 80° C. for one hour, and the aluminum foil was punched into a disk having a diameter of 15 mm using a blanking die. The positive electrode mix on the punched electrode was compressed using a hand press to a thickness of 38 to 42 μm. All the electrodes were prepared so as to have an amount of coating and a thickness within the above-specified ranges to have an identical electrode structure. After the electrodes were dried at 120° C., model cells were assembled. To avoid effects of moisture, all the operations were performed in a dry room.

The capacity and rate performance were evaluated using a three-electrode model cell simply simulating a battery. The three-electrode model cell was prepared in the following manner. The punched electrode with a diameter of 15 mm as a test sample, an aluminum electric collector, lithium metal for a counter electrode, and lithium metal for a reference electrode were stacked having a separator impregnated with an electrolyte between them. The electrolyte was a solution in which 0.8 weight percent VC (vinylene carbonate) was added to a 1 M solution of LiPF₆ dissolved in a solvent of ethylene carbonate (EC) and ethyl methyl carbonate (EMC), the ration being 1:2. The resulting laminate was sandwiched between two stainless steel (SUS) end plates and clamped with bolts. This was placed in a glass cell and thereby a three-electrode model cell was yielded.

Tests for the measurement of capacity and rate performance were performed in a glove box in an argon atmosphere. In the capacity measurement for the model cell, a constant-current (CC) charging was performed to a voltage of 4.5 V at a constant current of 0.1 mA, and, after the voltage reached 4.5 V, a constant-voltage (CV) charging was performed until the current decreased to 0.03 mA. Subsequently, a constant-current (CC) discharging was performed to 2 V at a constant current of 0.1 mA, and the discharge capacity in this process was defined as the capacity.

After subjecting each model cell to three cycles of the above cyclic charging and discharging, the rate performance was evaluated under the following conditions. Specifically, the model cell was subjected to a constant-current (CC) charging and a constant-voltage (CV) charging in the same manner as in the capacity measurement, and then subjected to a constant-current (CC) discharging at a constant current of 10 mA, and the capacity measured in this process was defined as the rate performance. All the tests were performed at room temperature (25° C.)

FIG. 5 is a charge-discharge curve in the capacity measurement of the electrode prepared using the olivine synthesized in Example 1.

Table 3 shows the capacities and the rate performances of the electrodes prepared by using the olivines synthesized in Examples 1 to 9 and Comparative Examples (Com. Ex. for short) 1 to 9.

TABLE 3

| | Capacity | Rate performance |
|---|---|---|
| | (0.1-mA discharge capacity) | (10-mA discharge capacity) |
| | (Ah/kg) | (Ah/kg) |
| Example 1 | 150 | 127 |
| Example 2 | 155 | 133 |
| Example 3 | 162 | 141 |
| Example 4 | 160 | 137 |
| Example 5 | 165 | 151 |
| Example 6 | 151 | 118 |
| Example 7 | 152 | 78 |
| Example 8 | 142 | 117 |
| Example 9 | 152 | 100 |
| Com. Ex. 1 | 121 | 45 |
| Com. Ex. 2 | 102 | 71 |
| Com. Ex. 3 | 138 | 112 |
| Com. Ex. 4 | 115 | 87 |
| Com. Ex. 5 | 155 | 141 |
| Com. Ex. 6 | 111 | 58 |
| Com. Ex. 7 | 53 | 5 |
| Com. Ex. 8 | 60 | 35 |
| Com. Ex. 9 | 21 | 8 |

The olivines synthesized in Example 1 and Comparative Example 2 have the same composition with each other and have particle diameters d substantially equal to each other. However, the electrode prepared by using the olivine synthesized in Example 1, which has higher crystallinity (a smaller ratio d/D), shows significantly higher capacity and rate performance than that prepared by using the olivine synthesized in Comparative Example 2, which has lower crystallinity (a larger ratio d/D), does.

Comparisons between Example 1 and Comparative Example 2, between Example 3 and Comparative Example 3, between Example 4 and Comparative Example 4, and between Example 5 and Comparative Example 5 show that an olivine having higher crystallinity (having a smaller ratio d/D) gives an electrode having both of a higher capacity and a higher rate performance, regardless of the compositions of the olivines. The degree (high or low) of crystallinity affects more on the capacity and rate performance as the amount of Fe decreases, namely, as the amount of Mn increases. These indicate that an olivine, when having an amount of 50% Fe or less in transition metals, can exhibit more significant advantageous effects of the present invention by controlling the ratio d/D to 1.35 or less so as to have higher crystallinity. The degree of crystallinity particularly significantly affects the properties when an olivine has a low Fe amount and thereby has a high Mn amount of 60% or more. This is probably due to a difference of lithium diffusibility between Mn and Fe. Mn has inferior lithium diffusibility to Fe while Fe has high lithium diffusibility. When an olivine includes a large amount of Mn, even slight decrease in diffusibility, which does not matter for an olivine including a large amount of Fe, significantly affects the properties.

Comparison among Example 1, Example 6, Example 7, and Comparative Example 1 shows that an olivine gives higher rate performance as the particle diameter decreases. The comparison also shows that the samples obtained in Example 1, Example 6, and Example 7 have satisfactory high capacities but the sample obtained in Comparative Example 1 has a low capacity. This indicates that an olivine having such a large particle diameter as 350 nm gives an electrode whose capacity is insufficient.

The comparison among Example 1, Example 6, Example 7, and Comparative Example 1 further shows the following results. A sample undergone presintering at a temperature higher than the crystallization temperature (around 420° C.) plus 200° C. has a low capacity and a low rate performance (Comparative Example 1). A sample undergone presintering at a temperature in the range of crystallization temperature plus 100° C. to crystallization temperature plus 200° C. has a high capacity but a somewhat low rate performance (Example 7). A sample undergone presintering at a temperature in the range of crystallization temperature plus 50° C. to crystallization temperature plus 100° C. has both of a high capacity and a good rate performance (Example 6). A sample undergone presintering at a temperature in the range of crystallization temperature to crystallization temperature plus 50° C. has both of a high capacity and a high rate performance (Example 1). These results show that the presintering temperature should not be greatly higher than the crystallization temperature, and preferably close to the crystallization temperature (and equal to or higher than the crystallization temperature). Specifically, the presintering temperature is equal to or higher than the crystallization temperature of the positive electrode active material and equal to or lower than the crystallization temperature plus 200° C. Preferably, the presintering temperature is equal to or higher than the crystallization temperature of the positive electrode active material and equal to or lower than the crystallization temperature plus 100° C. More preferably, the presintering temperature is equal to or higher than the crystallization temperature of the positive electrode active material and equal to or lower than the crystallization temperature plus 50° C.

Comparison among Example 1, Example 8, Example 9, Comparative Example 6, and Comparative Example 7 shows that the sample of Example 1, which has an amount of carbon coating of 2.7 weight percent, most excels in properties among them. Even the sample of Example 8, which has a large amount of carbon coating of 9.1 weight percent, shows a little deterioration in properties. The sample of Example 9, which has a small amount of carbon coating of 1.1 weight percent, has somewhat low rate performance. However, an active material having a small amount of carbon coating as in Example 9 is advantageously expected to effectively improve energy density per volume and to enable easy production of an electrode. In contrast, the sample of Comparative Example 6, which has an amount of carbon coating of 17 weight percent, suffers from significant deterioration in capacity and rate performance. This is probably because such an excessively thick carbon layer inhibits the diffusion of lithium ions. The sample of Comparative Example 7, which has an amount of carbon coating of 0.3 weight percent, suffers from significant deterioration in the properties. This is probably because the active material fails to have sufficient electric conductivity.

The sample of Comparative Example 8, which has not undergone presintering and thereby includes coarse particles, has poor properties and has significantly inferior performance compared to the sample of Comparative Example 2, which has a low crystallinity (has a large d/D) at a comparable level to Comparative Example 8. This is probably because the sample of Comparative Example 8 has an excessively large particle diameter d.

The sample of Comparative Example 9, which was prepared without pulverization and carbon coating of microparticles by ball milling after presintering, includes very large crystals and thereby suffers from significant deterioration incapacity and rate performance, hardly working as a battery.

What is claimed is:

1. A positive electrode active material for a lithium ion battery, comprising:
a material being represented by chemical formula LiMPO₄ where M includes at least one of iron, manganese, cobalt, and nickel;
wherein particles of the positive electrode active material have a diameter d in the range of 10 nm to 200 nm, the diameter d being determined by observation under a transmission electron microscope;
wherein a ratio d/D of the diameter d to a crystallite diameter D is in the range of 1 to 1.35, the crystallite diameter D being determined from a half width measured by X-ray diffraction; and
wherein the positive electrode active material is coated with carbon, an amount of the carbon being in the range of 1 weight percent to 10 weight percent.

2. The positive electrode active material according to claim 1,
wherein the percentage of iron in M of the chemical formula LiMPO₄ is 50% or less.

3. The positive electrode active material according to claim 1,
wherein the particles of the positive electrode active material have the diameter d in the range of 10 nm to 70 nm.

4. The positive electrode active material according to claim 1,
wherein the amount of the carbon is in the range of 2 weight percent to 5 weight percent.

5. A method for producing a positive electrode active material for a lithium ion battery, the positive electrode active material being represented by chemical formula LiMPO₄ where M includes at least one of iron, manganese, cobalt, and nickel, the method comprising the steps of:
mixing raw materials for the positive electrode active material;
presintering the mixed raw materials to give a presintered material;
mixing the presintered material with a carbon source; and
sintering the presintered material mixed with the carbon source,
wherein the step of presintering the mixed raw materials is performed at a temperature in the range of a crystallization temperature of the positive electrode active material to a temperature of the crystallization temperature plus 200° C.

6. A method for producing a positive electrode active material for a lithium ion battery, the positive electrode active material being represented by chemical formula AₓMB_{y}O_{z} where A denotes an alkali metal or alkaline earth metal, M includes at least one transition metal element, B denotes a main group element capable of forming an anion by covalent binding to oxygen, and x, y and z satisfy 0≦x≦2, 1≦y≦2 and 3≦z≦6, respectively, the method comprising the steps of:
mixing raw materials for the positive electrode active material;
presintering the mixed raw materials to give a presintered material;
mixing the presintered material with a carbon source; and
sintering the presintered material mixed with the carbon source,
wherein the step of presintering the mixed raw materials is performed at a temperature in the range of a crystallization temperature of the positive electrode active material to a temperature of the crystallization temperature plus 200° C.

7. A positive electrode active material for a lithium ion battery, produced by the method according to claim 5.

8. A positive electrode active material for a lithium ion battery, produced by the method according to claim 6.

9. The method according to claim 5,
wherein the step of presintering the mixed raw materials is performed at a temperature in the range of the crystallization temperature of the positive electrode active material to a temperature of the crystallization temperature plus 100° C.

10. The method according to claim 6,
wherein the step of presintering the mixed raw materials is performed at a temperature in the range of the crystallization temperature of the positive electrode active material to a temperature of the crystallization temperature plus 100° C.

11. The method according to claim 5,
wherein the step of presintering the mixed raw materials is performed at a temperature in the range of the crystallization temperature of the positive electrode active material to a temperature of the crystallization temperature plus 50° C.

12. The method according to claim 6,
wherein the step of presintering the mixed raw materials is performed at a temperature in the range of the crystallization temperature of the positive electrode active material to a temperature of the crystallization temperature plus 50° C.

13. The method according to claim 5,
wherein the step of presintering the mixed raw materials is performed in an oxidizing atmosphere.

14. The method according claim 6,
wherein the step of presintering the mixed raw materials is performed in an oxidizing atmosphere.

15. The method according to claim 5,
wherein the step of mixing the raw materials is performed by preparing a solution of the raw materials and drying the solution.

16. The method according to claim 6,
wherein the step of mixing the raw materials is performed by preparing a solution of the raw materials and drying the solution.

17. The method according to claim 5,
wherein the raw materials comprise at least one selected from the group consisting of an acetate, an oxalate, a citrate, a carbonate, and a tartrate, as a metal source.

18. The method according to claim 6,
wherein the raw materials comprise at least one selected from the group consisting of an acetate, an oxalate, a citrate, a carbonate, and a tartrate, as a metal source.

19. The method according to claim 5,
wherein the step of mixing the raw materials includes a step of adding an organic acid to the raw materials.

20. The method according to claim 6,
wherein the step of mixing the raw materials includes a step of adding an organic acid to the raw materials.

21. The method according to claim 19,
wherein the organic acid is citric acid.

22. The method according to claim 20,
wherein the organic acid is citric acid.

23. A positive electrode for a lithium ion battery, comprising:
a positive electrode mix including the positive electrode active material according to claim 1; and
a positive electrode electric collector.

24. A positive electrode for a lithium ion battery, comprising:
a positive electrode mix including the positive electrode active material according to claim 7; and
a positive electrode electric collector.

25. A positive electrode for a lithium ion battery, comprising:
a positive electrode mix including the positive electrode active material according to claim 8; and
a positive electrode electric collector.

26. A lithium ion battery comprising:
the positive electrode according to claim 23;
a negative electrode;
a separator disposed between the positive electrode and the negative electrode; and
an electrolyte.

27. A lithium ion battery comprising:
the positive electrode according to claim 24;
a negative electrode;
a separator disposed between the positive electrode and the negative electrode; and
an electrolyte.

28. A lithium ion battery comprising:
the positive electrode according to claim 25;
a negative electrode;
a separator disposed between the positive electrode and the negative electrode; and
an electrolyte.
